(19) United States
(12) Patent Application Publication
(10) Pub. No.: US 2017/0180220 A1
(43) Pub. Date: Jun. 22, 2017

(54) Techniques to Generate Workload Performance Fingerprints for Cloud Infrastructure Elements

(71) Applicant: Intel Corporation, Santa Clara, CA (US)

(72) Inventors: ALEXANDER LECKEY, KILCOCK (IE); THIJS METSCH, KOLN (DE); JOSEPH BUTLER, STAMULLEN CO MEATH (IE); MICHAEL J. MCGRATH, VIRGINIA (IE); VICTOR BAYON-MOLINO, MAYNOOTH (IE)

(73) Assignee: Intel Corporation, Santa Clara, CA (US)

(21) Appl. No.: 14/975,551

(22) Filed: Dec. 18, 2015

(51) Int. Cl. H04L 12/26; G06F 17/30; H04L 12/24; H04L 29/08; H04L 12/46

(52) U.S. Cl. CPC H04L 43/045; H04L 67/10; H04L 12/4641; H04L 41/0813; G06F 17/30864; G06F 17/30958

(57) ABSTRACT

Examples include techniques to generate workload performance fingerprints for cloud infrastructure elements. In some examples, performance metrics are obtained from resource elements or nodes included in an identified sub-graph that represents at least a portion of configurable computing resources of a cloud infrastructure. For these examples, averages for the performance metrics are determined and then stored at a top-level context information node for the identified sub-graph to represent a workload performance fingerprint for the identified sub-graph.

### RELATED CASE

This application is related to commonly owned U.S. patent application Ser. No. 14/582,102, filed on Dec. 23, 2014 and entitled “Techniques to Generate a Graph Model for Cloud Infrastructure Elements”.

### TECHNICAL FIELD

Examples described herein are generally related to pooled or configurable computing resources.

### BACKGROUND

Software define infrastructure (SDI) is a technological advancement that enables new ways to operate large pools of configurable computing resources deployed for use in a datacenter or as part of a cloud infrastructure. SDI may allow individual resource elements of a system of configurable computing resources to be composed with software. These resource elements may include physical elements, virtual elements or service elements. The composition of these resource elements may be based on fulfilling all or at least a portion of a workload.

### BRIEF DESCRIPTION OF THE DRAWINGS

FIG. 1 illustrates an example cloud infrastructure.

FIG. 2 illustrates an example landscape view.

FIG. 3 illustrates an example first context information.

FIG. 4 illustrates an example second context information.

FIG. 5 illustrates an example block diagram for an apparatus.

FIG. 6 illustrates an example of a logic flow.

FIG. 7 illustrates an example of a storage medium.

FIG. 8 illustrates an example computing platform.

### DETAILED DESCRIPTION

As contemplated in the present disclosure, SDI may allow individual resource elements of a system of configurable computing resources to be composed with software. Physical resource elements may include disaggregated physical elements that may be composed with software such as central processing units (CPUs), storage devices (e.g., hard/solid state disk drives), memory (e.g., random access memory), network input/output devices (e.g., network interface cards) or network switches. Virtualized resource elements may include virtual machines (VMs), containers, virtual local area networks (vLANs), block storage (virtual storage volumes) or virtual switches (vSwitches). Service resource elements may include management services, message queue services, security services, database services, webserver services or video processing services.

The above-mentioned resource elements may be arranged in complex and large arrangements of interrelated pieces when composed to support a cloud infrastructure. Current cloud infrastructure management tools may lack an ability to map certain compositions of resource elements referred to as “service stacks” to performance data for each node or resource element included in a given service stack. These tools also lack an ability to then aggregate performance data and summarize this data at a higher level to show both current and historical operating performance. It is with respect to these challenges that the examples described herein are needed.

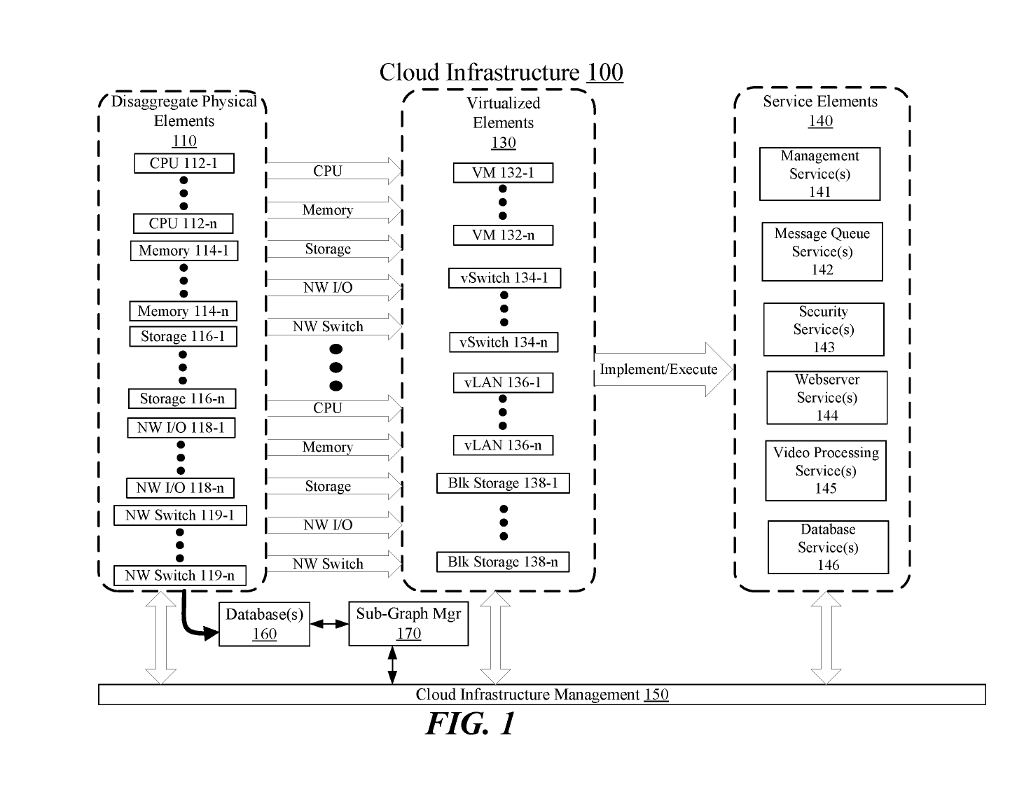

FIG. 1 illustrates an example cloud infrastructure 100. In some examples, as shown in FIG. 1, cloud infrastructure 100 includes various types of resource elements including disaggregate physical elements 110, virtualized elements 130 or service elements 140. In some examples, a cloud infrastructure management 150 may be arranged to manage or control at least some aspects of these types of resource elements. As described more below, in some examples, a sub-graph manager 170 may be capable of querying cloud infrastructure management 150 and database(s) 160 to gather information to identify one or more sub-graphs that include resource elements arranged to fulfill workloads, query performance metrics for resource elements and generate workload performance fingerprints for the one or more sub-graphs. Resource elements included in each sub-graph may be represented by a node in the sub-graph.

In some examples, generated workload performance fingerprints for a sub-graph may be mapped to resource elements or nodes and timestamped. Sub-graph manager 170 may be capable of comparing workload performance fingerprints for different sub-graphs or comparing workload performance fingerprints for the same sub-graph at different times (e.g., historical version comparison). The different sub-graphs may be associated with a same or similar service types and the comparisons of workload performance fingerprints may enable identification of optimizations within cloud infrastructure 100 and to facilitate capacity planning, schedule initial placement/composition options and determine rebalancing decisions for reconfiguring resource elements included in one or more sub-graphs.

According to some examples, as shown in FIG. 1, disaggregate physical elements 110 may include CPUs 112-1 to 112-n, where “n” is any positive integer greater than 1. CPUs 112-1 to 112-n may individually represent single microprocessors or may represent separate cores of a multi-core microprocessor. Disaggregate physical elements 110 may also include memory 114-1 to 114-n. Memory 114-1 to 114-n may represent various types of memory devices such as, but not limited to, dynamic random access memory (DRAM) devices that may be included in dual in-line memory modules (DIMMs) or other configurations. Disaggregate physical elements 110 may also include storage 116-1 to 116-n. Storage 116-1 to 116-n may represent various types of storage devices such as hard disk drives or solid state disk drives. Disaggregate physical elements 110 may also include network (NW) input/outputs (I/Os) 118-1 to 118-n. NW I/Os 118-1 to 118-n may include network interface cards (NICs) having one or more NW ports for network connections for NWs within cloud infrastructure 100 or external to cloud infrastructure 100. Disaggregate physical elements 110 may also include NW switches 119-1 to 119-n. NW switches 119-1 to 119-n may be capable of routing data via either internal or external network links for elements of cloud infrastructure 100.

In some examples, as shown in FIG. 1, virtualized elements 130 may include VMs 132-1 to 132-n, vSwitches 134-1 to 134-n, vLANs 136-1 to 136-n or virtual storage volumes/block storage 138-1 to 138-n. For these examples, each of these virtualized elements may be supported or hosted by disaggregate physical elements 120. For example, VM 132-1 may be supported or hosted by at least a CPU such as CPU 112-1 and supported by memory, storage, NW I/O or NW switch resource elements from among disaggregate physical elements 110.

According to some examples, virtualized elements 130 may be arranged to implement or execute service elements 140. As shown in FIG. 1, in some examples, service elements 140 may include management service(s) 141, message queue service(s) 142, security service(s) 143, webserver service(s) 144, video processing service(s) 145 or database service(s) 146. For these examples, VMs, vSwitches, vLANs or block storage from virtualized elements 130 may be used to implement or execute service elements 140 to fulfill a workload for a given service. For example, management service(s) 141 may use VM 132-1 to execute management related applications, video processing service(s) 145 may use block storage 136-1 for streaming video or message queue service(s) 142 may use vSwitch 134-n and/or vLAN 134-n to facilitate use of a multitude of message queues.

According to some examples, database(s) 160 may include information related to performance metrics obtain from disaggregate physical elements 110, virtualized elements 130 or service elements 140. For these examples, database(s) 160 may include one or more databases for these different types of resource elements. Databases for disaggregate physical elements 110, for example, may include performance metrics and/or capabilities for NW I/Os 118-1 to 118-n or NW switches 119-1 to 119-n. For example, number of ports or connections supported, data throughput capabilities, etc. Databases for disaggregate physical elements 110 may also include operating characteristics and/or capabilities for storage 116-1 to 116-n. For example, storage capacities, types of storage (e.g., hard disk or solid state), read/write rates, etc. Databases for disaggregate physical elements 110 may also include performance metrics and/or capabilities for CPUs 112-1 to 112-n or memory 114-1 to 114-n. For example, CPU operating frequencies, CPU cache capacities, types of CPU cache, memory capacity, types of memory, memory read/write rates, etc. Databases for virtualized elements 130 may also include similar performance metrics and/or capabilities that depend on what disaggregate physical elements 110 were arranged to support a given virtualized element. Likewise, databases for service elements 140 may also include performance metrics and/or capabilities that depend on what virtualized elements 130 were arranged to implement/execute a given service element.

In some examples, as described more below, sub-graph manager 170 may be capable of tracking performance metrics and/or capabilities of disaggregate physical elements 110, virtualized elements 130 or service elements 140 arranged as separate nodes of a given sub-graph and arranged to fulfill a given workload. The tracked performance metrics, for example, may be a type of contextual information that may include, but is not limited to, reputation/decay, uptimes, utilization patterns, sharing ratios, etc. Relationships may then be expressed between resource elements/nodes of the sub-graph such as, but not limited to, effective proximity, input/output and available quality of service (QoS). Sub-graph manager 170 may be able to identify one or more sub-graphs to generate a series of planes/graphs having physical, virtual and service layers each sub-graph including context information that may represent a workload performance fingerprint as resource elements included in the sub-graph fulfill a workload for any given date/time stamp.

According to some examples, workload performance fingerprints may be derived automatically, regardless of a type of service the resource elements of a given sub-graph are arranged to support/execute. Workload performance fingerprints may also be reproducible in that generation of workload performance fingerprints is repeatable to provenance them over time allowing for comparable historical results. Also, workload performance fingerprints may be comparable in that a first workload performance fingerprint for a first sub-graph may be compared to that on a second workload performance fingerprint for a second sub-graph, regardless of the service the resource elements of the first or second sub-graphs are arranged to support/execute.

In some examples, cloud infrastructure management 150 may maintain information such as unique identifier information for each element for disaggregate physical elements 110. Cloud infrastructure manager 150 may also be arranged to maintain information on how the various elements of cloud infrastructure 100 are arranged or configured to operate. For example, what disaggregate physical elements 110 are used to support virtualized elements 130 and what virtualized elements 130 implement/execute workload elements 140. These arrangements may be identified as separate sub-graphs and each resource element included in a sub-graph may be further identified as separate nodes in the sub-graph.

According to some examples, cloud infrastructure management 150 may include one or more monitoring services to monitor performance of the various resource elements of cloud infrastructure 100 to gather performance metrics that may be at least temporarily stored. Performance metrics may be based on meeting one or more QoS or a service-level agreement (SLA) requirements over one or more time periods or intervals. Cloud infrastructure management 150 may be capable of at least temporarily maintaining gathered performance metrics. In some examples, once performance metrics are gathered for determining a workload performance fingerprint, the performance metrics may then be archived.

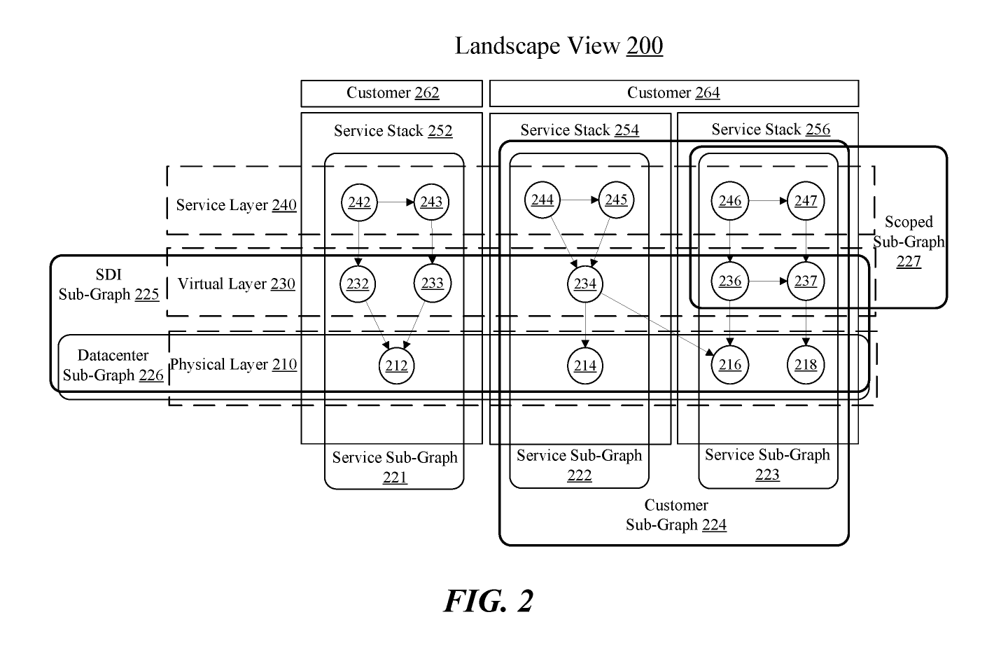

FIG. 2 illustrates example an example landscape view 200. In some examples, landscape view 200 may be snapshot view of a datacenter that as illustrated in FIG. 2 illustrates various different types of sub-graphs. As shown in FIG. 2, each sub-graph includes resource elements or nodes within multiple logical layers including a physical layer 210, a virtual layer 230 and service layer 240. For these examples, service layer 240 may capture those resource elements or nodes currently running services to fulfill workloads. Virtual layer 230 may track SDI resource elements or node such as VMs and/or containers, vLANs, vSwitches or block storage that may be arranged to execute/implement or support services. Physical layer 210 may have resource elements mapped to actual disaggregate physical elements such as CPUs, memory, storage (e.g., disks), NW I/O (e.g., NICs) or NW switches.

According to some examples, as shown in FIG. 2, landscape view 200 shows sub-graphs associated with providing services to a first customer 262 and to a second customer 264. For these examples, a service stack 252 may be capable of providing a service to customer 262 (e.g., management services). As shown in FIG. 2, service stack 252 includes a node 212 situated in physical layer 210, nodes 232 and 233 situated in virtual layer 230 and nodes 242 situated in service layer 240. Node 212, for example, may be a CPU resource element arranged to support nodes 232 and 233 which may be VMs and/or containers. Nodes 242 and 243 may be management services executed/implemented by nodes 232 and 233 to fulfill a management service workload.

In some examples, customer 264 may have multiple service stacks including a service stack 254 to provide a first service to customer 264 (e.g., message queue service) and a service stack 256 to provide a second service to customer 264 (e.g., database service). The second service provided by stack 256 may be a same type of service or may be a different type of service than the first service provided by stack 254.

According to some examples, as shown in FIG. 2, service stack 254 includes a node 214 situated in physical layer 210, a node 234 situated in virtual layer 230 and nodes 244 and 245 situated in service layer 240. Node 214, for example, may be a memory resource element arranged to support node 234 that may be a VM and/or container. Although shown in FIG. 2 as part of service stack 256, a node 216 situated in physical layer 210 may be a CPU resource element also arranged to support or host mode 234. Node 244 and 245 may be message queue services that utilize node 234 to fulfill a message queue service workload.

In some examples, as shown in FIG. 2, service stack 256 includes nodes 216 and 218 situated in physical layer 210, nodes 236 and 237 situated in virtual layer 230 and nodes 246 and 247 situated in service layer 240. Node 216, as mentioned previously, may be a CPU resource element arranged to support both node 234 from service stack 254 and node 236 from service stack 256. Node 218 may be a storage resource element arranged to support node 237. According to some examples, node 236 may be a VM and/or container and node 237 may a block storage resource element. Nodes 246 and 247 and may be database services that utilize respective nodes 236 and 237 to fulfill a database service workload.

According to some examples, as shown in FIG. 2, landscape view 200 may be divided into several different sub-graphs. A first type of sub-graph may be a service stack sub-graph. As shown in FIG. 2, service stack sub-graphs 221, 222 and 223 may represent these types of sub-graphs and include those nodes arranged to fulfill service workloads for respective service stacks 252, 254 and 256. A second type of sub-graph may be customer sub-graph. As shown in FIG. 2, customer sub-graph 224 includes those nodes arranged to fulfill service workloads for customer 264 via service stacks 254 and 256. A third type of sub-graph may be an SDI sub-graph. As shown in FIG. 2, SDI sub-graph 225 includes nodes situated in virtual layer 230 and physical layer 210 that may be part of a software designed infrastructure arranged to support various different service stacks for possibly multiple customers. A fourth type of sub-graph may be a datacenter sub-graph. As shown in FIG. 2, datacenter sub-graph 226 includes nodes situated in physical layer 210 that may be arranged to support various different service stack for possibly multiple customers. A fifth type of sub-graph may be a scoped sub-graph 227. As shown in FIG. 2, scoped sub-graph may include a portion of nodes of service stack 256. The portion may be selected to determine interactions of these nodes while fulfilling a service workload. Examples are not limited to scoped sub-graphs including nodes situated in a service layer and virtual layer. Other nodes in other layers are also contemplated. Also, examples are not limited to the five types of sub-graphs mentioned above and shown FIG. 2. Other types of sub-graphs having different combinations of nodes are contemplated.

In some examples, once a sub-graph has been identified that includes resource elements arranged to fulfill a service workload one or more performance metrics for the resource elements included in the sub-graph are queried and/or collected. For example, performance metrics for nodes 212, 232, 233, 242 and 243 for service sub-graph 221 may be queried and/or collected while these nodes fulfill respective portions of the service workload. As described more below, separate averages of the one or more performance metrics may be determined. The separate averages may then be at least temporarily stored at a top-level context information node (not shown in FIG. 2) for service sub-graph 221. The stored separate averages may be used to represent a workload performance fingerprint for sub-graph 221. Similar processes may be followed to generate workload performance fingerprints for each of the other sub-graphs shown in FIG. 2.

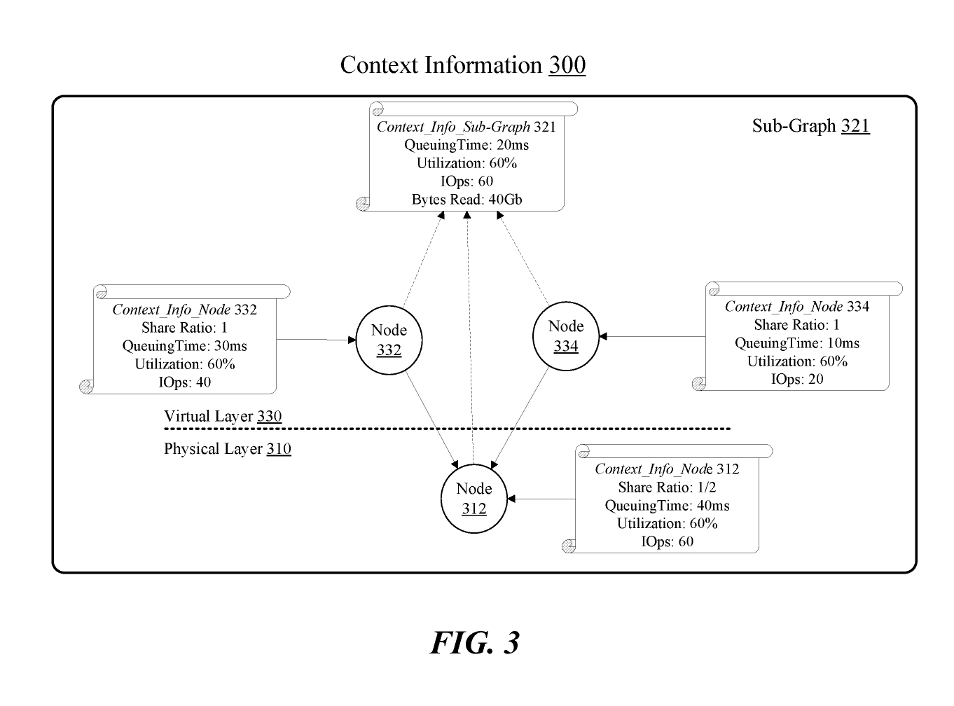

FIG. 3 illustrates an example context information 300. In some examples, context information 300 may be for a sub-graph 321. Sub-graph 321, as shown in FIG. 3, may be a type of scoped sub-graph that includes a node 312 situated in physical layer 310 and nodes 332 and 334 situated in virtual layer 330. Node 312 may be a resource element mapped to a disaggregate physical element such as a physical disk arranged for storage. Nodes 332 and 334 may be resource elements mapped to virtualized elements such as block storage or storage volume that may utilize node 312 for storage while fulfilling at least a portion of a service workload.

FIG. 3 shows a simple sub-graph with Context Info nodes for all individual nodes plus a Context Info node for sub-graph 321 itself. In some examples, key performance indicators (KPIs) or performance metrics such as, but not limited to, input/output per second (IOps), queuing time, share ratios, utilization, etc. may be tracked for each node of sub-graph 321. For these examples, these performance metrics for each node may be stored with each node. For example, Context_Info_Node 312, Context_Info_Node 332 and Context_Info_Node 334 may at least temporarily store KPIs or performance metrics for nodes 312, 332 and 334, respectively.

In some examples, separate averages of the KPIs or performance metrics for nodes 312, 332 and 334 may be determined and these separate averages may be stored, at least temporarily, at a top-level Context Info node for sub-graph 321 that is shown in FIG. 3 as Context_Info_Sub-Graph 321. For example, the performance metric of QueingTime: 20 milliseconds (ms) shown in Context_Info_Sub-Graph 321 may be an average of the queuing times observed by nodes 332 and 334 for accessing storage maintained by node 312 while fulfilling at least a portion of a service workload. Utilization of 60% may be an average utilization percentage for node 312 by nodes 332 and 334 while fulfilling at least the portion of the service workload. Meanwhile IOps: 60 may be an average IOps observed for an access rate of node 312 by nodes 332 and 334 while fulfilling at least the portion of the service workload. Bytes Read: 40 gigabits (Gb) may be an determined average of bytes read from node 312 by nodes 332 and 334 or may be a total read from block storage maintained by nodes 332 and/or 334 and access by service layer resource elements (not shown) while fulfilling at least the portion of the service workload. For these examples, the determined separate averages for the various performance metrics shown in Context_Info_Sub-Graph 321 may represent a workload performance fingerprint for sub-graph 321.

According to some examples, a beginning time/date and an ending time/date may be assigned to Context_Info_Sub-Graph 321 to establish a first date-based version of the workload performance fingerprint for sub-graph 321. A comparison of the first date-based version of the workload performance fingerprint may be made to a second date-based version for another workload performance fingerprint for sub-graph 321. The second data-based version having an earlier assigned beginning time/date and earlier assigned ending time/date compared to the first date-based version. Based on the comparison of the two date-based versions, resource elements included in sub-graph 321 may be reconfigured and/or replaced. For example, increases in average queuing times indicated by the comparison may indicated that storage capacity of node 312 may be inadequate. Node 312 may then be replaced with another resource element having a larger storage capacity as part of a possible reconfiguration of sub-graph 321 resource elements.

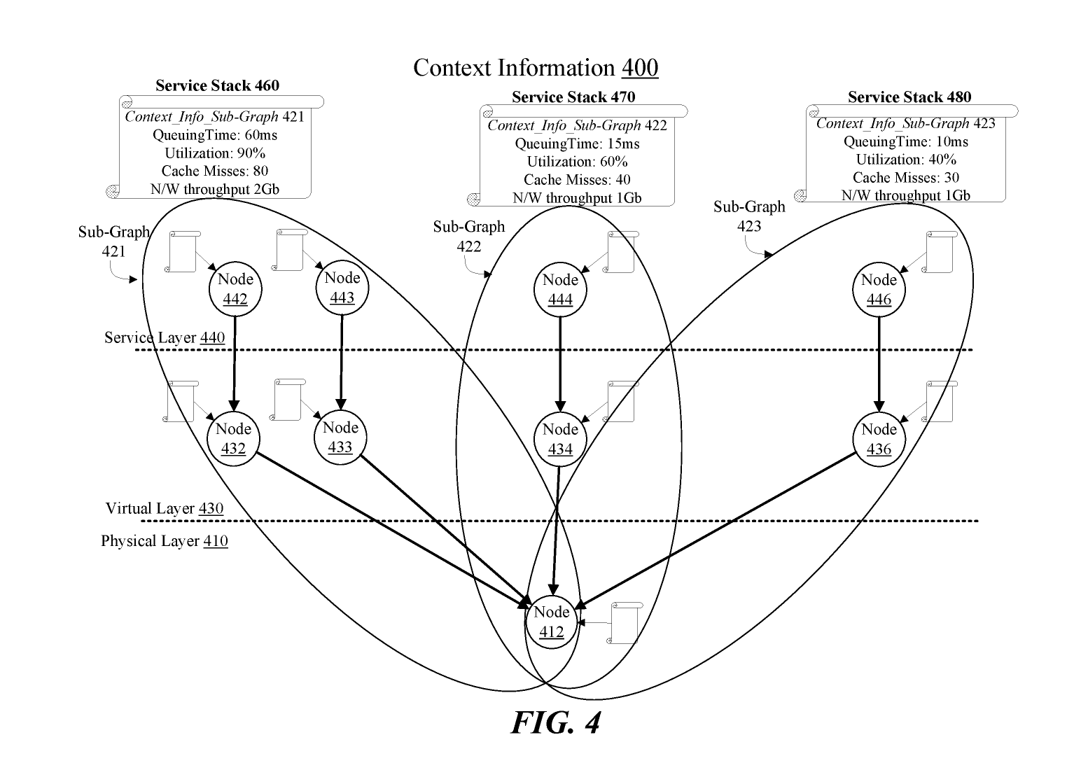

FIG. 4 illustrates an example context information 400. In some examples, context information 400 may illustrate Context Info for multiple sub-graphs 421, 422 and 423. Sub-graphs 421, 422 and 423 may be a type of service stack sub-graph for service stacks 460, 470 and 480. As shown in FIG. 4 a single node 412 situated in physical layer 410 may be arranged to support or host each of the end-to-end service stacks included in sub-graphs 421, 422 and 423. Node 412 may be a resource element mapped to a disaggregate physical element such as a CPU.

According to some examples, Nodes 432 and 433 of sub-graph 421 situated in virtual layer 420 may be VMs and/or containers hosted by node 412. Nodes 432 and 433 may be arranged to implement/execute nodes 442 and 443 situated in service layer 440. Nodes 442 and 443, in some examples, may be service applications for fulfilling a first workload associated with service stack 460.

In some examples, Node 434 of sub-graph 422 situated in virtual layer 420 may a VM and/or container hosted by node 412. Node 434 may be arranged to implement/execute node 444 situated in service layer 440. Node 444, in some examples, may be a service application for fulfilling a second workload associated with service stack 470.

According to some examples, Node 436 of sub-graph 423 situated in virtual layer 420 may be a VM and/or container hosted by node 412. Node 436 may be arranged to implement/execute node 446 situated in service layer 440. Node 446, in some examples, may be a service application for fulfilling a third workload associated with service stack 480.

In some examples, as illustrated in FIG. 4, separate scrolls pointing to the nodes in sub-graphs 421, 422 or 423 may represent separately maintained Context Info nodes for individual nodes. For these examples, Context_Info_Sub-Graph 421, Context_Info_Sub-Graph 422 and Context_Info_Sub-Graph 423 may include average performance metrics determined based on performance metrics queried from each respective sub-graph's nodes while fulfilling workloads associated with each respective service stack and thus may represent respective workload performance fingerprints for each respective service stack or sub-graph. For example, separate averages maintained in Context_Info_Sub-Graph 421 may represent a first workload performance fingerprint for service stack 460 or sub-graph 421. Also, separate averages maintained in Context_Info_Sub-Graph 422 may represent a second workload performance fingerprint for service stack 470 or sub-graph 422. Also, separate averages maintained in Context_Info_Sub-Graph 423 may represent a third workload performance fingerprint for service stack 480 or sub-graph 423.

According to some examples, service stacks 460, 470 and 480 may provide similar services. For example, each service may provide webserver services. For these examples, the first, second and third workload performance fingerprints represented in respective Context_Info_Sub-Graph 421, Context_Info_Sub-Graph 422 and Context_Info_Sub-Graph 423 may be compared. As shown in FIG. 4, the first workload performance fingerprint for service stack 460 indicates average queueing time, utilization rate and cache misses that are substantially higher than the second and third workload performance fingerprints for service stacks 470 and 480. This indication may warrant a reconfiguration of the resource elements or nodes included in sub-graph 421 to cause the first workload performance fingerprints to more closely match the second and third workload performance fingerprints. A datacenter operator or manager may cause a reconfiguration of the nodes included in sub-graph 421 such as adding more memory or CPU resource elements to reduce cache misses or adding additional storage resource elements to reduce queuing times.

In some other examples, a comparison between just the second and third workload performance fingerprints may be made based on these sub-graphs having a relatively same number of resource elements. However, these sub-graphs may be configured in somewhat different ways. For example, sub-graph 480 may have CPU resource elements that have more on-die memory than the CPU resource elements allocated to sub-graph 470. For these examples, a datacenter operator or manager may cause a reconfiguration of the nodes included in sub-graph 422 to substantially match a configuration of the nodes included in sub-graph 423 based on the third workload performance fingerprint for sub-graph 423 indicating better average performance metrics. For examples, queuing time, utilization and cache misses all have comparatively better averages as shown for Context_Info_Sub-Graph 423 compared to Context_Info_Sub-Graph 422. The reconfiguration of the nodes included in sub-graph 422 may cause these nodes to substantially match the configuration of the nodes included in sub-graph 423 and thus may improve at least some of the performance metrics for service stack 470.

The service stacks and sub-graphs for each service stacks may depict only a portion of nodes that may be included in a service stack. For example, several additional nodes may be situated in physical layer 410 to support or host nodes situated in virtual layer 430 (e.g., storage, memory, NW I/O, etc.). Also, several additional nodes may be situated in virtual layer 430 to implement/execute nodes situated in service layer 440 (e.g., vLAN, vSwitch, block storage, etc.). Thus, examples are not limited to service stacks including the few nodes shown in FIG. 4. Sub-graphs for service stacks may have any number of nodes that provide performance metrics that may be queried, averaged and then stored at a top-level context information node to represent a workload performance fingerprint for nodes included in that service stack or sub-graph.

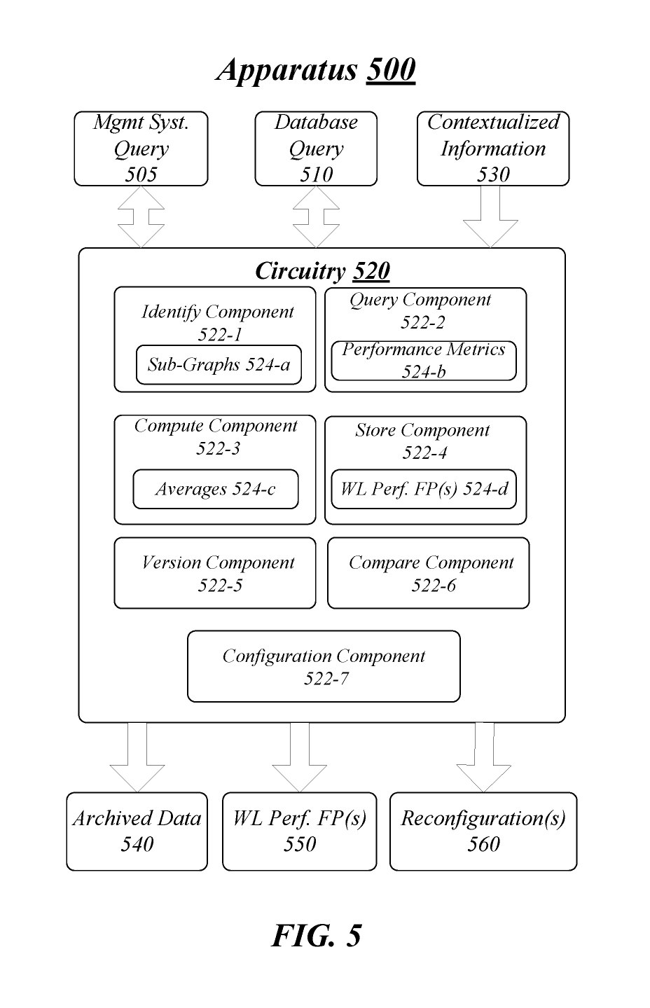

FIG. 5 illustrates an example block diagram for apparatus 500. Although apparatus 500 shown in FIG. 5 has a limited number of elements in a certain topology, it may be appreciated that the apparatus 500 may include more or less elements in alternate topologies as desired for a given implementation.

According to some examples, apparatus 500 may be supported by circuitry 520 maintained at or with management elements for a system of configurable computing resources of a cloud infrastructure such as sub-graph manager 170 shown in FIG. 1 for cloud infrastructure 100. Circuitry 520 may be arranged to execute one or more software or firmware implemented modules or components 522-a (module or component may be used interchangeably in this context). It is worthy to note that “a” and “b” and “c” and similar designators as used herein are intended to be variables representing any positive integer. Thus, for example, if an implementation sets a value for a=7, then a complete set of software or firmware for components 522-a may include components 522-1, 522-2, 522-3, 522-4, 522-5, 522-6 or 522-7. The examples presented are not limited in this context and the different variables used throughout may represent the same or different integer values. Also, these “components” may be software/firmware stored in computer-readable media, and although the components are shown in FIG. 5 as discrete boxes, this does not limit these components to storage in distinct computer-readable media components (e.g., a separate memory, etc.).

According to some examples, circuitry 520 may include a processor, processor circuit or processor circuitry. Circuitry 520 may be part of host processor circuitry that supports a management element for cloud infrastructure such as graph manager 170. Circuitry 520 may be generally arranged to execute one or more software components 522-a. Circuitry 520 may be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Atom®, Celeron®, Core (2) Duo®, Core i3, Core i5, Core i7, Itanium®, Pentium®, Xeon®, Xeon Phi® and XScale® processors; and similar processors. According to some examples circuitry 520 may also include an application specific integrated circuit (ASIC) and at least some components 522-a may be implemented as hardware elements of the ASIC.

According to some examples, apparatus 500 may include an identify component 522-1. Identify component 522-1 may be executed by circuitry 520 to identify a first sub-graph that includes resource elements or nodes of a system of configurable computing resources of a cloud infrastructure. The resource elements or nodes may be arranged to fulfill a first workload. For these examples, identify component 522-1 may maintained information related to identified sub-graphs with sub-graphs 524-a in a data structure such as a look up table (LUT).

In some examples, apparatus 500 may include a query component 522-2. Query component 522-2 may be executed by circuitry 520 to one or more performance metrics from separate resource elements of the first sub-graph, the one or more performance metrics generated while the separate resource elements fulfill respective portions of the workload. For these examples, the one or more performance metrics may be obtained from the separate resource elements via management system query 505 or from database query 510. Management system query 505, for example, may be information received from cloud infrastructure management elements such as cloud infrastructure management 150 that gathered performance metrics from resource elements. Database query 510, for example, may be information received from one or more databases that may include information regarding disaggregate physical elements, virtualized elements or service elements of the cloud infrastructure such as database(s) 160. Contextualized information 530 may also include performance metrics obtained directly from one or more resource elements of the first sub-graph. Query component 522-2 may maintain, at least temporarily, the one or more performance metrics with performance metrics 524-b. In some examples, for longer term storage, the performance metrics may be archived via archived data 540 after a set amount of time (e.g., every 24 hours).

In some examples, apparatus 500 may also include compute component 522-3. Compute component 522-3 may be executed by circuitry 520 to determine separate averages of the one or more performance metrics for the resource elements of the first sub-graph. For these examples, compute component 522-3 may maintain, at least temporarily, the determined separate averages with averages 524-c (e.g., in a LUT). In some examples, for longer term storage, the determined separate averages may be archived via archived data 540 after a set amount of time (e.g., every 24 hours).

According to some examples, apparatus 500 may also include a store component 522-4. Store component 522-4 may be executed by circuitry 520 to add each element to store, at least temporarily, the separate averages at a top-level context information node for the first sub-graph, the stored separate averages to represent a first workload performance fingerprint for the first sub-graph. For these examples, store component 522-3 may maintain the first workload performance fingerprint with workload (WL) performance finger(s) (FP(s)) 524-d (e.g., in a LUT). In some examples, for longer term storage, the first workload performance fingerprint may be archived via WL performance FP(s) 550 after a set amount of time (e.g., every day, once a month or once a week).

In some examples, apparatus 500 may also include a version component 522-5. Version component 522-5 may be executed by circuitry 520 to assign a beginning time/date and an ending time/date to establish a first date-based version of the first workload performance fingerprint for the first sub-graph. The established version may be included with the first workload performance fingerprint maintained by store component 522-4 with WL performance FP(s) 524-d.

According to some examples, apparatus 500 may also include a compare component 522-6. Compare component 522-6 may be executed by circuitry 520 to compare the first workload performance fingerprint with other workload performance fingerprints. In some examples, comparisons may be made between different versions of workload performance fingerprints. In other examples, comparisons may be made between workload performance fingerprints of different sub-graphs.

In some examples, apparatus 500 may also include a configuration component 522-7. Configuration component 522-7 may be executed by circuitry 520 to cause reconfigurations of resource elements included in a sub-graph based on comparisons conducted by compare component 522-6. For these examples, reconfiguration(s) 560 may cause the resource elements to be reconfigured such that two sub-graphs may be reconfigured to substantially match each other's configuration based on the workload performance fingerprint comparison showing that such a reconfiguration may improve performance metrics for resource elements included in at least one of the two sub-graphs.

Various components of apparatus 500 and a device or node implementing apparatus 500 may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Example connections include parallel interfaces, serial interfaces, and bus interfaces.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

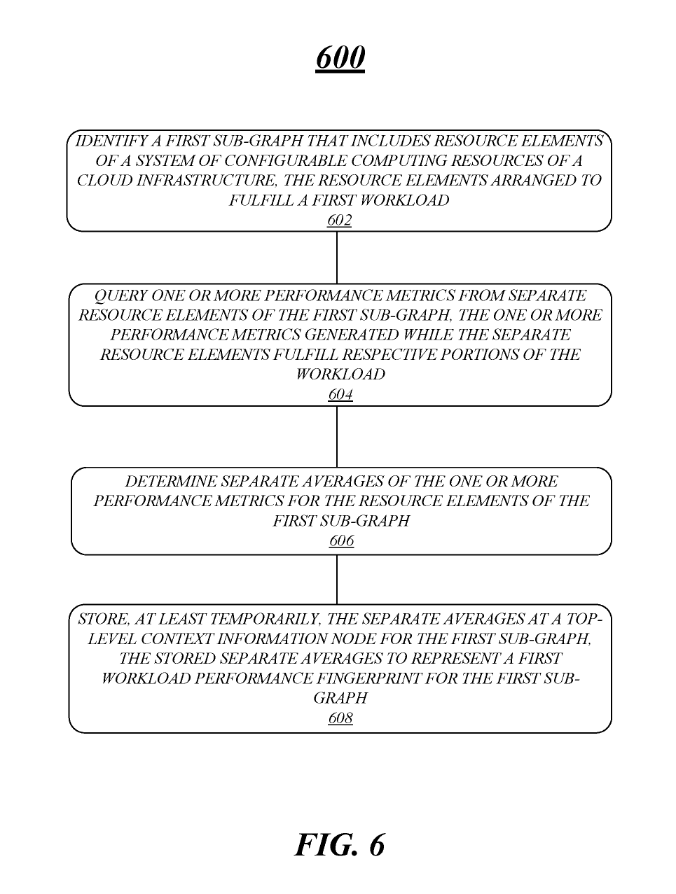

FIG. 6 illustrates an example logic flow 600. Logic flow 600 may be representative of some or all of the operations executed by one or more logic, features, or devices described herein, such as apparatus 500. More particularly, logic flow 600 may be implemented by at least identify component 522-1, query component 522-2, compute component 522-3 or store component 522-4.

According to some examples, logic flow 600 at block 602 may identify a first sub-graph that includes resource elements of a system of configurable computing resources of a cloud infrastructure, the resource elements arranged to fulfill a first workload. For these examples, identify component 522-1 may identify the first sub-graph.

In some examples, logic flow 600 at block 604 may query one or more performance metrics from separate resource elements of the first sub-graph, the one or more performance metrics generated while the separate resource elements fulfill respective portions of the workload. For these examples, query component 522-2 may conduct the query.

According to some examples, logic flow 600 at block 606 may determine separate averages of the one or more performance metrics for the resource elements of the first sub-graph. For these examples, compute component 522-3 may determine the separate averages.

In some examples, logic flow 600 at block 608 may store, at least temporarily, the separate averages at a top-level context information node for the first sub-graph, the stored separate averages to represent a first workload performance fingerprint for the first sub-graph. For these examples, store component 522-4 may store the separate averages at the top-level context information node.

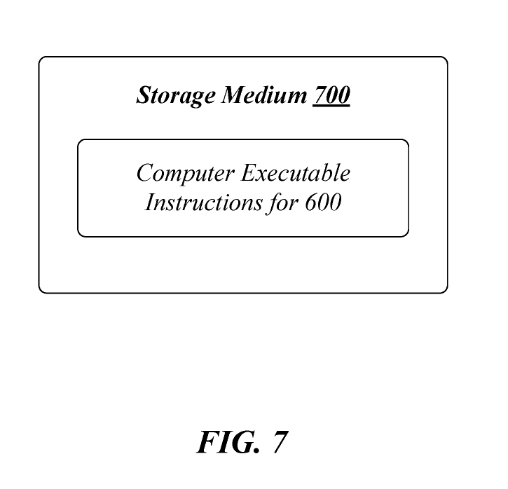

FIG. 7 illustrates an example storage medium 700. As shown in FIG. 7, the first storage medium includes a storage medium 700. The storage medium 700 may comprise an article of manufacture. In some examples, storage medium 700 may include any non-transitory computer readable medium or machine readable medium, such as an optical, magnetic or semiconductor storage. Storage medium 700 may store various types of computer executable instructions, such as instructions to implement logic flow 600. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

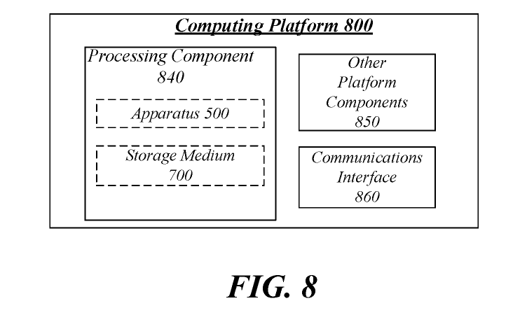

FIG. 8 illustrates an example computing platform 800. In some examples, as shown in FIG. 8, computing platform 800 may include a processing component 840, other platform components 850 or a communications interface 860. According to some examples, computing platform 800 may host management elements (e.g., sub-graph manager) providing management functionality for a system of configurable computing resources of a cloud infrastructure such as cloud infrastructure 100 of FIG. 1.

According to some examples, processing component 840 may execute processing operations or logic for apparatus 500 and/or storage medium 700. Processing component 840 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 850 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 860 may include logic and/or features to support a communication interface. For these examples, communications interface 860 may include one or more communication interfaces that operate according to various communication protocols or standards to communicate over direct or network communication links. Direct communications may occur via use of communication protocols or standards described in one or more industry standards (including progenies and variants) such as those associated with the PCIe specification. Network communications may occur via use of communication protocols or standards such those described in one or more Ethernet standards promulgated by IEEE. For example, one such Ethernet standard may include IEEE 802.3-2012, Carrier sense Multiple access with Collision Detection (CSMA/CD) Access Method and Physical Layer Specifications, Published in December 2012 (“IEEE 802.3”). Network communication may also occur according to one or more OpenFlow specifications such as the OpenFlow Hardware Abstraction API Specification. Network communications may also occur according to Infiniband Architecture specification.

As mentioned above computing platform 800 may be implemented in a server or client computing device. Accordingly, functions and/or specific configurations of computing platform 800 described herein, may be included or omitted in various embodiments of computing platform 800, as suitably desired for a server or client computing device.

The components and features of computing platform 800 may be implemented using any combination of discrete circuitry, application specific integrated circuits (ASICs), logic gates and/or single chip architectures. Further, the features of computing platform 800 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary computing platform 800 shown in the block diagram of FIG. 8 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled” or “coupled with”, however, may also mean that two or more elements are not in direct contact with each other, but yet still co-operate or interact with each other.

The follow examples pertain to additional examples of technologies disclosed herein.

### Example 1

An example apparatus may include circuitry and an identify component for execution by the circuitry to identify a first sub-graph that includes resource elements of a system of configurable computing resources of a cloud infrastructure. The resource elements may be arranged to fulfill a first workload. The apparatus may also include a query component for execution by the circuitry to query one or more performance metrics for separate resource elements of the first sub-graph. The one or more performance metrics may be generated while the separate resource elements fulfill respective portions of the workload. The apparatus may also include a compute component for execution by the circuitry to determine separate averages of the one or more performance metrics for the resource elements of the first sub-graph. The apparatus may also include a store component for execution by the circuitry to add each element to store, at least temporarily, the separate averages at a top-level context information node for the first sub-graph. For these examples, the stored separate averages may represent a first workload performance fingerprint for the first sub-graph.

### Example 2

The apparatus of example 1 may also include a compare component for execution by the circuitry to compare the first workload performance fingerprint for the first sub-graph to a second workload performance fingerprint for a second sub-graph that includes resource elements arranged to fulfill a second workload similar to the first workload. The example apparatus may also include a configuration component for execution by the circuitry to cause the resource elements included in the first or the second sub-graph to be reconfigured based on the comparison.

### Example 3

The apparatus of example 2, the compare component may determine that the first workload performance fingerprint indicates better performance for the first sub-graph in fulfilling the first workload compared to the second sub-graph in fulfilling the second workload. For these examples, the configuration component may cause the resource elements included in the second sub-graph to substantially match a configuration of the resource elements included in the first sub-graph.

### Example 4

The apparatus of example 1 may also include a version component for execution by the circuitry to assign a beginning time/date and an ending time/date to establish a first date-based version of the first workload performance fingerprint for the first sub-graph. The apparatus may also include a compare component for execution by the circuitry to compare the first date-based version of the first workload performance fingerprint to a second date-based version of a second work performance fingerprint for the first sub-graph, the second workload performance fingerprint having an earlier assigned beginning time/date and earlier assigned ending time/date compared to the first date-based version. The apparatus may also include a configuration component for execution by the circuitry to cause the resource elements included in the first sub-graph to be reconfigured based on the comparison.

### Example 5

The apparatus of example 4, the compare component may determine that the first workload performance fingerprint indicates better performance for fulfilling the first workload compared to the second workload performance fingerprint in fulfilling the first workload. For these examples, the configuration component may cause the resource elements in the first sub-graph to substantially match a configuration of the resource elements while fulfilling the first workload during the earlier assigned beginning and ending times/dates.

### Example 6

The apparatus of example 1, the query component may query the one or more performance metrics queried from a cloud infrastructure management system and from separate databases for respective resource elements included in the first sub-graph.

### Example 7

The apparatus of example 1, the resource elements of the system of configurable computing resources may include individual disaggregate physical elements, virtualized elements or service elements.

### Example 8

The apparatus of example 7, the disaggregate physical elements may include central processing units, memory devices, storage devices, network input/output devices or network switches.

### Example 9

The apparatus of example 7, the virtualized elements may include virtual machines, virtual local area networks, virtual switches, virtual local area networks or logically assigned block storage.

### Example 10

The apparatus of example 7, the service elements may include management services, message queue services, security services, database services, webserver services or video processing services.

### Example 11

The apparatus of example 1 may also include a digital display coupled to the circuitry to present a user interface view.

### Example 12

An example method may include identifying, at a processor circuit, a first sub-graph that includes resource elements of a system of configurable computing resources of a cloud infrastructure. The resource elements may be arranged to fulfill a first workload. The method may also include querying one or more performance metrics from separate resource elements of the first sub-graph. The one or more performance metrics may be generated while the separate resource elements fulfill respective portions of the workload. The method may also include determining separate averages of the one or more performance metrics for the resource elements of the first sub-graph. The method may also include storing, at least temporarily, the separate averages at a top-level context information node for the first sub-graph. The stored separate averages may represent a first workload performance fingerprint for the first sub-graph.

### Example 13

The method of example 12 may also include comparing the first workload performance fingerprint for the first sub-graph to a second workload performance fingerprint for a second sub-graph that includes resource elements arranged to fulfill a second workload similar to the first workload. The method may also include reconfiguring the first or the second sub-graph based on the comparison.

### Example 14

The method of example 13, reconfiguring the first or the second sub-graph may include determining that the first workload performance fingerprint indicates better performance for the first sub-graph in fulfilling the first workload compared to the second sub-graph in fulfilling the second workload. Reconfiguring the first or the second sub-graph may also include reconfiguring the resource elements included in the second sub-graph to substantially match a configuration of the resource elements included in the first sub-graph.

### Example 15

The method of example 12 may also include assigning a beginning time/date and an ending time/date to establish a first date-based version of the first workload performance fingerprint for the first sub-graph. The method may also include comparing the first date-based version of the first workload performance fingerprint to a second date-based version of a second work performance fingerprint for the first sub-graph, the second workload performance fingerprint having an earlier assigned beginning time/date and earlier assigned ending time/date compared to the first date-based version. The method may also include reconfiguring the resource elements included in the first sub-graph based on the comparison.

### Example 16

The method of example 15, reconfiguring the resource elements of the first sub-graph may include determining that the first workload performance fingerprint indicates better performance for fulfilling the first workload compared to the second workload performance fingerprint in fulfilling the first workload. Reconfiguring the resource elements of the first sub-graph may also include reconfiguring the resource elements in the first sub-graph to substantially match a configuration of the resource elements while fulfilling the first workload during the earlier assigned beginning and ending times/dates.

### Example 17

The method of example 12, the one or more performance metrics may be queried from a cloud infrastructure management system and from separate databases for respective resource elements included in the first sub-graph.

### Example 18

The method of example 12, the resource elements of the system of configurable computing resources may include individual disaggregate physical elements, virtualized elements or service elements.

### Example 19

The method of example 18, the disaggregate physical elements may include central processing units, memory devices, storage devices, network input/output devices or network switches.

### Example 20

The method of example 18, the virtualized elements may include virtual machines, virtual local area networks, virtual switches, virtual local area networks, or logically assigned block storage.

### Example 21

The method of example 18, the service elements may include management services, message queue services, security services, database services, webserver services or video processing services.

### Example 22

An example at least one machine readable medium may include a plurality of instructions that in response to being executed by system at a server may cause the system to carry out a method according to any one of examples 12 to 21.

### Example 23

An example apparatus may include means for performing the methods of any one of examples 12 to 21.

### Example 24

An example at least one machine readable medium may include a plurality of instructions that in response to being executed by circuitry located with a system of configurable computing resources of a cloud infrastructure may cause the circuitry to identify a first sub-graph that includes resource elements of a system of configurable computing resources of a cloud infrastructure. The resource elements may be arranged to fulfill a first workload. The instructions may also cause the circuitry to query one or more performance metrics for separate resource elements of the first sub-graph. The one or more performance metrics may be generated while the separate resource elements fulfill respective portions of the workload. The instructions may also cause the circuitry to determine separate averages of the one or more performance metrics for the resource elements of the first sub-graph. The instructions may also cause the circuitry to store, at least temporarily, the separate averages at a top-level context information node for the first sub-graph. The stored separate averages may represent a first workload performance fingerprint for the first sub-graph.

### Example 25

The at least one machine readable medium of example 24, the instructions may further cause the circuitry to compare the first workload performance fingerprint for the first sub-graph to a second workload performance fingerprint for a second sub-graph that includes resource elements arranged to fulfill a second workload similar to the first workload. The instructions may also cause the circuitry to cause the resource elements included in the first or the second sub-graph to be reconfigured based on the comparison.

### Example 26

The at least one machine readable medium of example 23, the instructions may further cause the circuitry to determine that the first workload performance fingerprint indicates better performance for the first sub-graph in fulfilling the first workload compared to the second sub-graph in fulfilling the second workload. The instructions may also cause the circuitry to cause the resource elements included in the second sub-graph to substantially match a configuration of the resource elements included in the first sub-graph.

### Example 27

The at least one machine readable medium of example 24, the instructions may further cause the circuitry to assign a beginning time/date and an ending time/date to establish a first date-based version of the first workload performance fingerprint for the first sub-graph. The instructions may also cause the circuitry to compare the first date-based version of the first workload performance fingerprint to a second date-based version of a second work performance fingerprint for the first sub-graph, the second workload performance fingerprint having an earlier assigned beginning time/date and earlier assigned ending time/date compared to the first date-based version. The instructions may also cause the circuitry to cause the resource elements included in the first sub-graph to be reconfigured based on the comparison.

### Example 28

The at least one machine readable medium of example 24, the instructions may further cause the circuitry to determine that the first workload performance fingerprint indicates better performance for fulfilling the first workload compared to the second workload performance fingerprint in fulfilling the first workload. The instructions may also cause the circuitry to cause the resource elements in the first sub-graph to substantially match a configuration of the resource elements while fulfilling the first workload during the earlier assigned beginning and ending times/dates.

### Example 29

The at least one machine readable medium of example 24, the instructions may also cause the circuitry to query the one or more performance metrics queried from a cloud infrastructure management system and from separate databases for respective resource elements included in the first sub-graph.

### Example 30

The at least one machine readable medium of example 24, the resource elements of the system of configurable computing resources may include individual disaggregate physical elements, virtualized elements or service elements.

### Example 31

The at least one machine readable medium of example 30, the disaggregate physical elements may include central processing units, memory devices, storage devices, network input/output devices or network switches.

### Example 32

The at least one machine readable medium of example 30, the virtualized elements may include virtual machines, virtual local area networks, virtual switches, virtual local area networks or logically assigned block storage.

### Example 33

The at least one machine readable medium of example 30, the service elements may include management services, message queue services, security services, database services, webserver services or video processing services.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
circuitry;
an identify component for execution by the circuitry to identify a first sub-graph that includes resource elements of a system of configurable computing resources of a cloud infrastructure, the resource elements arranged to fulfill a first workload;
a query component for execution by the circuitry to query one or more performance metrics for separate resource elements of the first sub-graph, the one or more performance metrics generated while the separate resource elements fulfill respective portions of the workload;
a compute component for execution by the circuitry to determine separate averages of the one or more performance metrics for the resource elements of the first sub-graph; and
a store component for execution by the circuitry to add each element to store, at least temporarily, the separate averages at a top-level context information node for the first sub-graph, the stored separate averages to represent a first workload performance fingerprint for the first sub-graph.

2. The apparatus of claim 1, comprising:
a compare component for execution by the circuitry to compare the first workload performance fingerprint for the first sub-graph to a second workload performance fingerprint for a second sub-graph that includes resource elements arranged to fulfill a second workload similar to the first workload; and
a configuration component for execution by the circuitry to cause the resource elements included in the first or the second sub-graph to be reconfigured based on the comparison.

3. The apparatus of claim 2, comprising:
the compare component to determine that the first workload performance fingerprint indicates better performance for the first sub-graph in fulfilling the first workload compared to the second sub-graph in fulfilling the second workload; and
the configuration component to cause the resource elements included in the second sub-graph to substantially match a configuration of the resource elements included in the first sub-graph.

4. The apparatus of claim 1, comprising:
a version component for execution by the circuitry to assign a beginning time/date and an ending time/date to establish a first date-based version of the first workload performance fingerprint for the first sub-graph;
a compare component for execution by the circuitry to compare the first date-based version of the first workload performance fingerprint to a second date-based version of a second work performance fingerprint for the first sub-graph, the second workload performance fingerprint having an earlier assigned beginning time/date and earlier assigned ending time/date compared to the first date-based version; and
a configuration component for execution by the circuitry to cause the resource elements included in the first sub-graph to be reconfigured based on the comparison.

5. The apparatus of claim 4, comprising:
the compare component to determine that the first workload performance fingerprint indicates better performance for fulfilling the first workload compared to the second workload performance fingerprint in fulfilling the first workload; and
the configuration component to cause the resource elements in the first sub-graph to substantially match a configuration of the resource elements while fulfilling the first workload during the earlier assigned beginning and ending times/dates.

6. The apparatus of claim 1, comprising the query component to query the one or more performance metrics queried from a cloud infrastructure management system and from separate databases for respective resource elements included in the first sub-graph.

7. The apparatus of claim 1, the resource elements of the system of configurable computing resources including individual disaggregate physical elements, virtualized elements or service elements.

8. The apparatus of claim 7, the disaggregate physical elements comprising central processing units, memory devices, storage devices, network input/output devices or network switches.

9. The apparatus of claim 7, the virtualized elements comprising virtual machines, virtual local area networks, virtual switches, virtual local area networks or logically assigned block storage.

10. The apparatus of claim 7, the service elements comprising management services, message queue services, security services, database services, webserver services or video processing services.

11. The apparatus of claim 1, comprising a digital display coupled to the circuitry to present a user interface view.

12. A method comprising:
identifying, at a processor circuit, a first sub-graph that includes resource elements of a system of configurable computing resources of a cloud infrastructure, the resource elements arranged to fulfill a first workload;
querying one or more performance metrics from separate resource elements of the first sub-graph, the one or more performance metrics generated while the separate resource elements fulfill respective portions of the workload;
determining separate averages of the one or more performance metrics for the resource elements of the first sub-graph; and
storing, at least temporarily, the separate averages at a top-level context information node for the first sub-graph, the stored separate averages to represent a first workload performance fingerprint for the first sub-graph.

13. The method of claim 12, comprising:
comparing the first workload performance fingerprint for the first sub-graph to a second workload performance fingerprint for a second sub-graph that includes resource elements arranged to fulfill a second workload similar to the first workload; and
reconfiguring the first or the second sub-graph based on the comparison.

14. The method of claim 13, reconfiguring the first or the second sub-graph comprises:
determining that the first workload performance fingerprint indicates better performance for the first sub-graph in fulfilling the first workload compared to the second sub-graph in fulfilling the second workload; and
reconfiguring the resource elements included in the second sub-graph to substantially match a configuration of the resource elements included in the first sub-graph.

15. The method of claim 12, comprising:
assigning a beginning time/date and an ending time/date to establish a first date-based version of the first workload performance fingerprint for the first sub-graph;
comparing the first date-based version of the first workload performance fingerprint to a second date-based version of a second work performance fingerprint for the first sub-graph, the second workload performance fingerprint having an earlier assigned beginning time/date and earlier assigned ending time/date compared to the first date-based version; and
reconfiguring the resource elements included in the first sub-graph based on the comparison.

16. The method of claim 15, reconfiguring the resource elements of the first sub-graph comprises:
determining that the first workload performance fingerprint indicates better performance for fulfilling the first workload compared to the second workload performance fingerprint in fulfilling the first workload; and
reconfiguring the resource elements in the first sub-graph to substantially match a configuration of the resource elements while fulfilling the first workload during the earlier assigned beginning and ending times/dates.

17. The method of claim 12, the resource elements of the system of configurable computing resources including individual disaggregate physical elements, virtualized elements or service elements.

18. The method of claim 17, the disaggregate physical elements comprising central processing units, memory devices, storage devices, network input/output devices or network switches.

19. The method of claim 17, the virtualized elements comprising virtual machines, virtual local area networks, virtual switches, virtual local area networks, or logically assigned block storage.

20. The method of claim 17, the service elements comprising management services, message queue services, security services, database services, webserver services or video processing services.

21. At least one machine readable medium comprising a plurality of instructions that in response to being executed by circuitry located with a system of configurable computing resources of a cloud infrastructure cause the circuitry to:
identify a first sub-graph that includes resource elements of a system of configurable computing resources of a cloud infrastructure, the resource elements arranged to fulfill a first workload;
query one or more performance metrics for separate resource elements of the first sub-graph, the one or more performance metrics generated while the separate resource elements fulfill respective portions of the workload;
determine separate averages of the one or more performance metrics for the resource elements of the first sub-graph; and
store, at least temporarily, the separate averages at a top-level context information node for the first sub-graph, the stored separate averages to represent a first workload performance fingerprint for the first sub-graph.

22. The at least one machine readable medium of claim 21, the resource elements of the system of configurable computing resources including individual disaggregate physical elements, virtualized elements or service elements.

23. The at least one machine readable medium of claim 22, the disaggregate physical elements comprising central processing units, memory devices, storage devices, network input/output devices or network switches.

24. The at least one machine readable medium of claim 22, the virtualized elements comprising virtual machines, virtual local area networks, virtual switches, virtual local area networks or logically assigned block storage.

25. The at least one machine readable medium of claim 22, the service elements comprising management services, message queue services, security services, database services, webserver services or video processing services.
